(19) United States
(12) Patent Application Publication
(10) Pub. No.: US 2007/0169881 A1
(43) Pub. Date: Jul. 26, 2007

(54) METHOD FOR MANUFACTURING MICROELECTRODE AND MICROELECTRODE MANUFACTURED BY THE SAME

(76) Inventors: Takuya MATSUMOTO, Kyoto-shi (JP); Sinji Matsui, Himeji-shi (JP); Kenichiro Nakamatsu, Aioi-shi (JP); Kaoru Ojima, Ibaraki-shi (JP); Tomoji Kawai, Minoo-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/692,350

(22) Filed: Mar. 28, 2007

Related U.S. Application Data
(63) Continuation of application No. PCT/JP05/05584, filed on Mar. 25, 2006.

(30) Foreign Application Priority Data
Sep. 28, 2004 (JP) 2004-282564

(51) Int. Cl. B32B 37/00

(52) U.S. Cl. 156/249

(57) ABSTRACT

A method for manufacturing a microelectrode includes one of allocating organic molecules or forming an organic molecular layer on a first substrate, applying a release agent onto a desired pattern formed on a second substrate, attaching an electrode material to the release agent, and bonding a surface of the second substrate to which the electrode material is attached and a surface of the first substrate on which the organic molecules are allocated or the organic molecular layer is formed to transfer the electrode material to the first substrate.

### CROSS-REFERENCE TO RELATED APPLICATIONS

This is a Continuation Application of PCT Application No. PCT/JP2005/005584, filed Mar. 25, 2005, which was published under PCT Article 21(2) in Japanese.

This application is based upon and claims the benefit of priority from prior Japanese Patent Application No. 2004-282564, filed Sep. 28, 2004, the entire contents of which are incorporated herein by reference.

### BACKGROUND OF THE INVENTION

1. Field of the Invention

The present invention relates to a method for manufacturing a microelectrode of nanoscale and the microelectrode manufactured by means of the same.

2. Description of the Related Art

In recent years, the development of the fine processing technology and molecular synthesis technology requires the preparation of devices by using functions of a single molecule or several molecules. The organic molecule is the smallest unit showing a function and has an advantage of enabling the mass production of molecules having various characteristics in units of Avogadro's number by the technology of synthetic chemistry. The molecule is known to have a self-organization structure, that is a characteristic called a self-organization structure on a substrate due to its structure. Further, as shown by the possibility of orientating and orientation-controlling a molecular structure of nanoscale (hereinafter referred to as “nanomolecular structure” or simply as “molecular structure”) depending on the development conditions on the substrate, the surface science has a large background about the molecular structures on the substrate and has therefore a good prospect in the technical application to molecular devices.

In order to manufacture a device directly utilizing such a nanomolecular structure, an electrode having a gap width smaller than the size of this nanomolecular structure (in the present description, such a extremely minute electrode is collectively referred to as “microelectrode”) is required.

For manufacturing a microelectrode, there are two methods referred to as a bottom contact method and a top contact method.

The bottom contact method is a method of manufacturing an electrode structure on a substrate and then developing a molecular structure on the electrode. The top contact method is a method of manufacturing an electrode structure after developing a molecular structure on a substrate. It is reported that the top contact method shows a higher electric contact conductance when both methods are compared to each other (refer to Non-Pat. Document 1). Accordingly, it is a very important issue whether the electrode is manufactured before or after developing the molecular structures. In particular, a nanogap electrode of top contact method having little influence on the formation of nanomolecular structures and having a gap size similar to the nonomolecular structures is useful for a molecular device utilizing molecular structures developed on a flat substrate surface. For a bottom contact method, a step is formed between the electrode and the substrate, causing the deformation of the molecular structure allocated on the electrode. Thus, the original function of a molecule is not demonstrated (refer to FIG. 7). Further, organic molecules are often developed on the electrode from a solution. However, if there is a step, the solution accumulates in the step portion, and after the solvent has evaporated, an aggregate of molecules remains there. In this condition, the dispersed molecules cannot be connected to the electrode, being a serious obstacle for forming a molecule-scale device. Moreover, for a bottom contact method, a molecule might have different affinity for the surfaces between electrodes and insulating part, causing the problem of inhibiting the development of the self-organization structure on the electrode. Accordingly, as in the top contact method, it is necessary to avoid deformed molecules and molecules aggregated on the electrode edge by allocating a molecular structure on a flat substrate and forming an electrode thereon. However, in the lithography methods used for silicon semiconductors, severe reaction conditions such as resist, electron irradiation and etching process are used for the formation of an electrode. Thus, organic molecules cannot withstand these processes.

As a method of forming an electrode without using such conditions, a method of manufacturing an electrode (gold electrode) of top contact method by means of transfer is described in Non-Pat. Document 2.

In this method, first, a pattern is formed on one substrate, and then, gold is deposited thereon by means of vapor deposition. On the other substrate, SiO₂ is formed, and MPTMS (3-mercaptopropyltrimethoxysilane: made by Aldrich Chemical Co.) is formed thereon as a SAM (self-assembled monolayer). By using the bonding power between S (sulfur) and gold, gold is transferred to the other substrate. In this case, attention must be paid to the possibility of reactions between molecules and chemical substances due to the chemical processing performed on the other substrate for transferring gold as an electrode.

Non-Patent Document 1: Appl. Phys. Lett. 82 (2003) 793

Non-Patent Document 2: J. AM. CHEM. SOC. 2002, 124, 7654-7655

### BRIEF SUMMARY OF THE INVENTION

An object of the present invention is to provide a method for manufacturing a good microelectrode without affecting molecules and a microelectrode manufactured by the method.

A method for manufacturing a microelectrode according to an aspect of the present invention characterized by comprising: one of allocating organic molecules or forming an organic molecular layer on a first substrate; applying a release agent onto a desired pattern formed on a second substrate; attaching an electrode material to the release agent; and bonding a surface of the second substrate to which the electrode material is attached and a surface of the first substrate on which the organic molecules are allocated or the organic molecular layer is formed to transfer the electrode material to the first substrate. As a result, an electrode of top contact method can be formed without using processes deteriorating molecules by heat, organic solvents and chemical reactions. And the process of forming the electrode is very simple.

### BRIEF DESCRIPTION OF THE SEVERAL VIEWS OF THE DRAWING

FIG. 1A is a view showing the flow of a manufacturing method of a microelectrode according to one embodiment of the present invention;

FIG. 1B is a view showing the flow of a manufacturing method of a microelectrode according to one embodiment of the present invention;

FIG. 1C is a view showing the flow of a manufacturing method of a microelectrode according to one embodiment of the present invention;

FIG. 1D is a view showing the flow of a manufacturing method of a microelectrode according to one embodiment of the present invention;

FIG. 1E is a view showing the flow of a manufacturing method of a microelectrode according to one embodiment of the present invention;

FIG. 2A is a view showing an example of an electrode manufactured according to the procedure of FIGS. 1A and 1B and having a line width of 500 nm;

FIG. 2B is a view showing an example of an electrode manufactured according to the procedures of FIGS. 1A to 1E and having a line width of 500 nm;

FIG. 3A is a view showing an example of a pattern of the microelectrode manufactured by means of the method of FIGS. 1A and 1B;

FIG. 3B is a view showing an example of a pattern of the microelectrode manufactured by means of the method of FIGS. 1A and 1B;

FIG. 4A is a view showing the measurements of electric characteristics between the ends of one electrode pattern;

FIG. 4B is a view showing the measurements of electric characteristics between the ends of one electrode pattern;

FIG. 5A is a view showing a circuit configuration for measuring the electric resistance when molecular structures (nanotubes) are immobilized as dispersed (allocated) before the formation of the electrode;

FIG. 5B is a graph showing the result of the measurements performed by means of the circuit of FIG. 5A;

FIG. 6 is a view showing the connection condition between a nanotube and an electrode;

FIG. 7 is a view illustrating the problems of a bottom contact method electrode manufacturing method;

FIG. 8 is a view showing an optical microscope image of an electrode transferred on an organic matter (polyaniline) by means of the manufacturing method according to the present embodiment; (a) is a view showing the optical microscope image of the electrode; and (b) is a view enlarging the vicinity of the center of (a); and

FIG. 9 is a view showing an optical microscope image of an electrode transferred on sapphire by means of the manufacturing method according to the present embodiment.

### DETAILED DESCRIPTION OF THE INVENTION

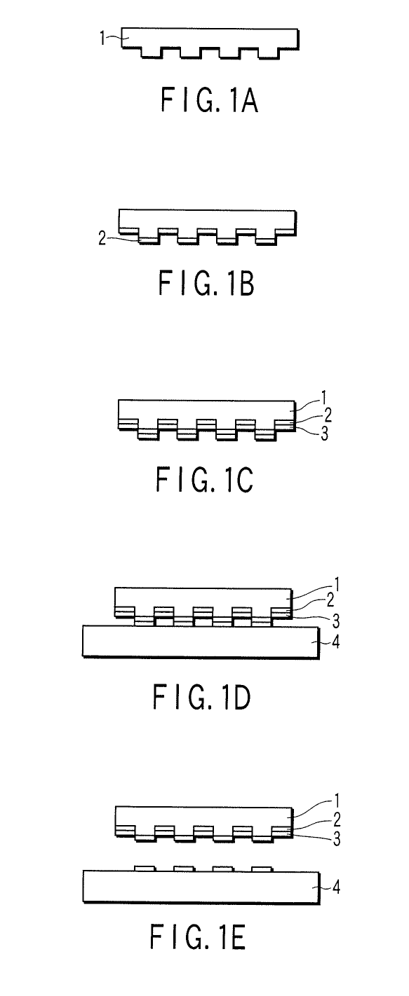

An embodiment of the present invention will be described with reference to the drawings. FIGS. 1A to 1E are views showing the flow of a manufacturing method of a microelectrode according to one embodiment of the present invention. The present invention applies to a microelectrode with the top contact method. Similar to in Non-Patent Document 2, an electrode is formed by a transfer.

First, a substrate 1 used as a mold for transferring an electrode (hereinafter, referred to as “first substrate”) and a substrate 4 for being transferred to (hereinafter, referred to as “second substrate”) are manufactured. Then a pattern is formed (molded: FIG. 1A) on one surface of the first substrate 1. Incidentally, the pattern is formed on the Si-substrate by an electron beam lithography. Here, a molecular structure is allocated on one surface of the second substrate 4 in advance. Instead of allocating a molecular structure, a molecular layer may be formed on one surface of the first substrate 1.

Then, in order to facilitate the transfer of an electrode material to the second substrate 4, a release agent 2 is applied on the formed pattern by spin coat (release agent application: FIG. 1B). Thereafter, the electrode material is attached to the release agent 2 (electrode material attachment: FIG. 1C).

Then, the surface of the first substrate 1 to which the electrode material 3 is attached and the surface of the second substrate 4 on which the molecule structure is allocated are brought in close contact with each other by applying pressure, transferring the electrode material 3 to the second substrate 4 (transferring: FIG. 1D). Thereby, an electrode can be formed by the top contact method (FIG. 1E).

The electrode material 3 manufactured by the above-described method must satisfy the following conditions:

(a) Not to be oxidized: Since a thin gold layer is formed in the mold and is transferred, it is a necessary condition for the electrode material not to be oxidized.

(b) To have an excellent ductility: In order to realize a transfer of nanosize microelectrode, it is necessary that the electrode material has an excellent ductility and that the metallic electrode is transferred and pressure-bonded to the nanosize irregularities of the substrate.

As the most suitable material satisfying the above-described conditions, gold is most preferable, however, the material is not limited to gold, and, for example, platinum, copper and aluminum may be also used. In addition, by using gold as the electrode material 3, a self-organization layer having a thiol group can enhance the fixity of the electrode on the substrate. Similar reactions are reported for precious metals such as platinum and palladium as well as for copper. However, at present, a reaction between gold and thiol is the most profoundly investigated reaction bonding metal and organic molecular layer to each other.

Using the above-described method, an electrode was actually manufactured. Gold was used as the electrode material 3. More specifically, the preparation method is as follows:

(1) Mold preparation: An Si-substrate was manufactured and an SiO₂ layer of 200 nm was formed on the surface of the substrate. A pattern was formed on the SiO₂ layer by the electron beam lithography. However, not only electron bean lithography, but also other known semiconductor technologies (etching and others) can be used for forming a pattern.

(2) Release agent application: A release agent 2 (optoolIDSX (release agent concentrate solution): Demnumsolvent (solvent)=1:1000; made by DAIKIN INDUSTRIES, LTD.) was applied to the pattern. At this time, the release agent 2 is preferably applied to the concave and convex portions in FIG. 1B completely.

(3) Electrode material attachment: Gold was attached as the electrode material 3 on the release agent 2 of 40 nm by vapor deposition. In attaching the electrode material 3, an attachment method by means of spattering can be employed. However, in order to reduce burrs in transferring the electrode material 3, a method preventing the electrode material 3 from being attached to the side walls of the concave portions (recess portions) of the pattern is preferably employed. Accordingly, as the method of attaching the electrode material 3 to the first substrate 1, an attachment method by means of vapor deposition is preferably employed.

(4) Transfer: In order to transfer the electrode material 3 to the second substrate 4, the attachment surface of the electrode material 3 and the surface on which the molecular structure was allocated are pressure-bonded to each other. The pressure bonding was performed by raising pressure to 10,000N with spending one minute (not only the pressure of 10,000N, but also the pressure in the order of not destructing the molecular structure may be used) and maintaining the pressure for three minutes. In addition, the temperature was a room temperature (25° C.) and the pressure bonding was performed in a low vacuum (in the order of 10⁻³ Torr) environment so as to suppress the influences of molecules and dust in the air to the maximum extent possible.

(5) Completion: The first substrate 1 and the second substrate 4 were separated gradually from each other with spending one minute so as to transfer the electrode material 3 to the second substrate 4 without defects.

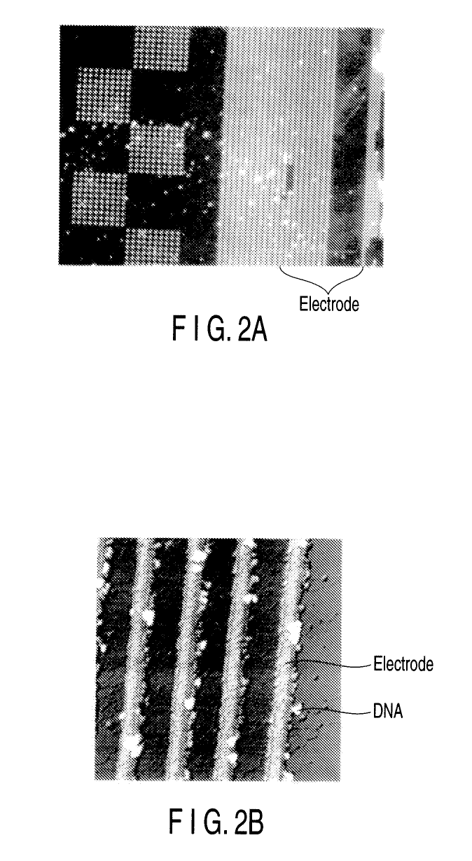

FIGS. 2A and 2B show an electrode manufactured according to the above-described procedure and having a line width of 500 nm. In FIGS. 2A and 2B, FIG. 2A is an electrode pattern image observed by means of an optical microscope and FIG. 2B is an electrode pattern image observed by means of an AFM (atomic force microscope). As shown in FIGS. 2A and 2B, it can be seen that the electrode manufactured according to the above-described method has neither destructed molecular structures (DNAs) nor defects. As described above, a microelectrode can be manufactured without destructing the microscopic DNA molecules allocated on the substrate.

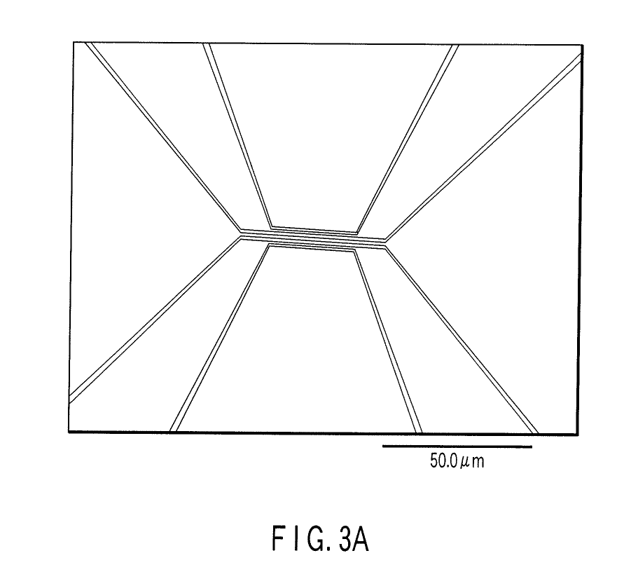

FIGS. 3A and 3B show an example of a pattern of the microelectrode manufactured by means of the above-described method. FIG. 3A shows an optical microscope image and FIG. 3B shows an AFM image. Using this electrode pattern, the electric characteristics were measured.

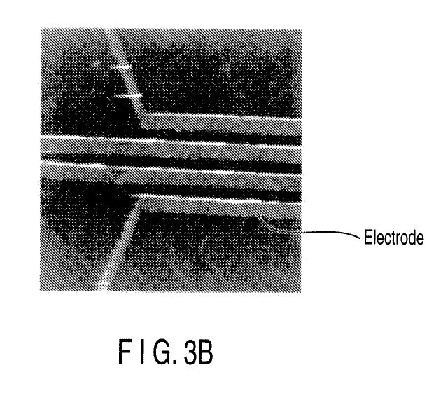

FIGS. 4A and 4B are views showing the electric characteristics between the ends of one electrode pattern. FIG. 4A is a measuring circuit diagram and FIG. 4B is a graph showing the result of the measurements. In the graph of FIG. 4A, the vertical axis represents the current value and the horizontal axis represents the bias voltage. In FIG. 4B, the electric resistance of the electrode is about 1 kiloohm, and the I-V curve at that time shows good ohmic characteristics. The electric resistance between the adjacent electrodes is not shown, however, it shows a higher value than the measuring limit.

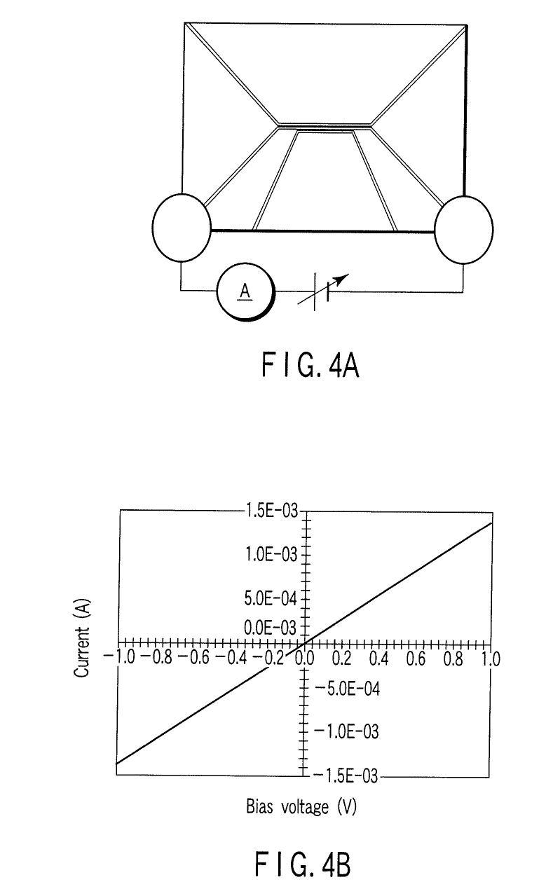

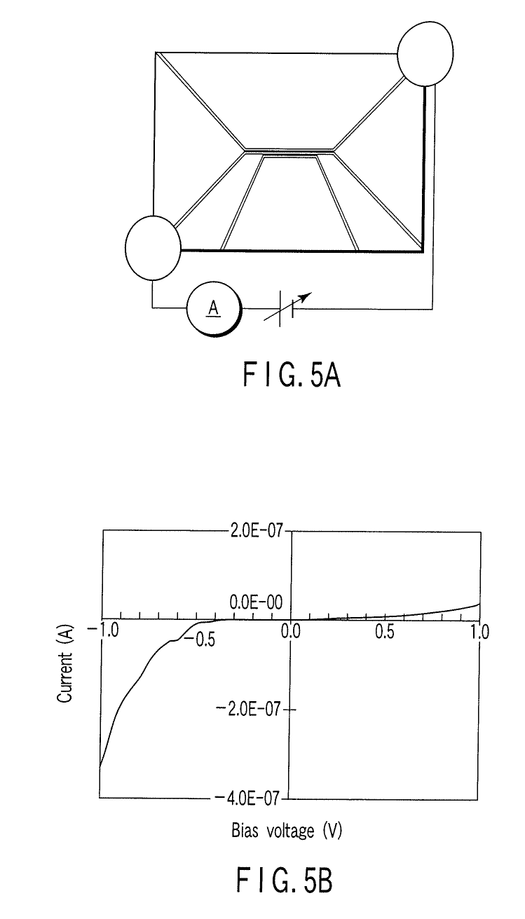

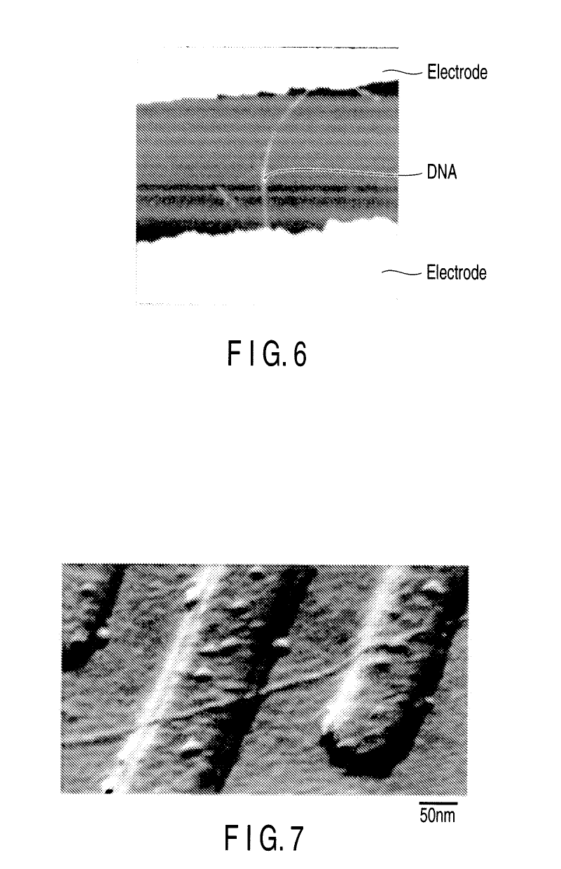

FIGS. 5A and 5B show the result of the measurements of the electric resistance when molecular structures (nanotubes) are immobilized as dispersed (allocated) before the formation of the microelectrode. Incidentally, FIG. 6 is a view showing the connection condition between a nanotube and an electrode. FIG. 5A is a measuring circuit diagram and FIG. 5B is a graph showing the result of the measurements. In addition, in the graph of FIG. 5B, the vertical axis represents the current value and the horizontal axis represents the bias voltage. As shown in FIG. 5B, reflecting the electronic properties of the nanotube, energy gap was observed.

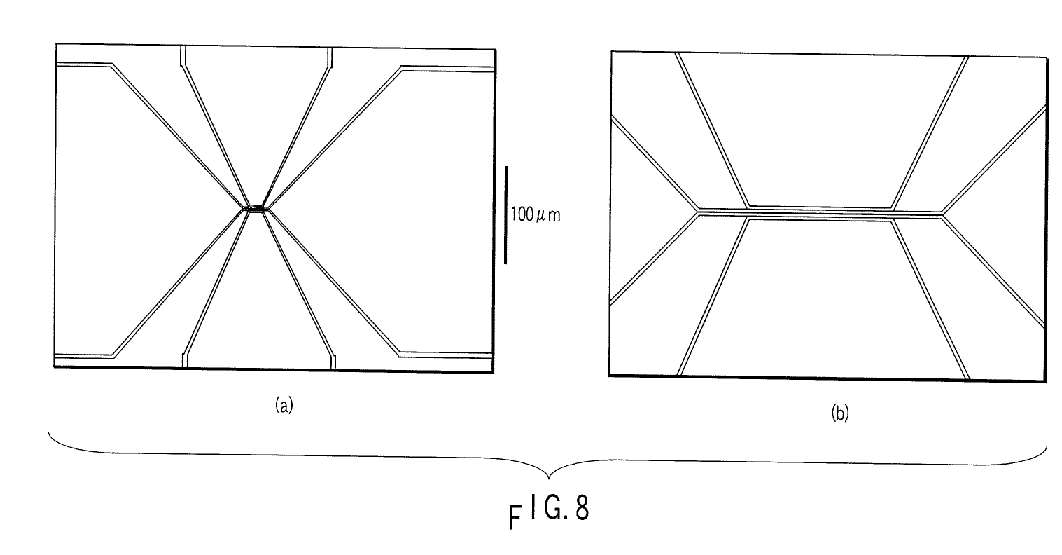

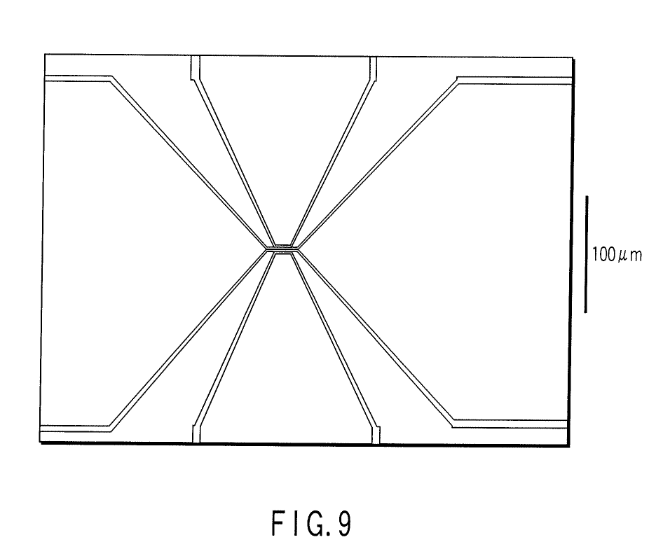

FIG. 8 is a view showing an optical microscope image of the electrode transferred on an organic matter (polyaniline) by means of the manufacturing method according to the present embodiment. In FIG. 8, FIG. 8(a) is a view showing the optical microscope image of the electrode and FIG. 8(b) is a view enlarging the vicinity of the center of FIG. 8(a). FIG. 9 is a view showing an optical microscope image of an electrode transferred on sapphire by means of the manufacturing method according to the present embodiment. As shown in FIGS. 8 and 9, according to the embodiment of the present invention, an extremely minute electrode, for example, an electrode of nanoscale, can be transferred on various materials.

According to the embodiment of the present invention, since the microelectrode formed as described above shows good ohmic characteristics, it can be satisfactorily used as an electrode. In addition, the electrode can be formed without destructing molecular structures. Further, the microelectrode manufactured according to the present embodiment has a extremely small contact resistance, and therefore, a wiring with small power loss can be realized. Accordingly, according to the present invention, a good microelectrode formed can be manufactured by the top contact method. As described above, the microelectrode and the manufacturing method thereof according to the embodiment of the present invention can solve the conventional problem described above. In addition, molecular electronics are going to be applied to a paper-like foldable computer and a new computation system for performing network type information processings as a human brain. The present invention relates to the essential technology supporting all of these molecular devices and the applications thereof include all the devices utilizing molecules. Thus, the present invention has an extremely wide variety of possibilities.

The present invention is not limited to the above-described embodiment, and various modifications can be made without departing from the gist of the invention in the implementation phase.

In the above-described embodiment, a case where one mold is prepared for manufacturing each of the microelectrode is described. The mold is generally disposable, and in the above-described embodiment, a mold must be manufactured from the beginning for each transfer. Therefore, it is preferable to manufacture a template in advance, to transfer the shape of the template to a general polymer material such as a PDMS for mass-producing molds, to apply a release agent to the mold and to perform transfer by means of vapor deposition of gold. Thereby, a lot of molds can be produced from one template cheaply and easily.

In addition, as the first substrate a semiconductor (Si) substrate is provided and molecular structures are allocated after SiO₂ has been formed on the surface, however, an oxidized surface of metal may be used. Further, according to the embodiment of the present invention, an electrode can be formed without affecting the molecular structures on the first substrate. Accordingly, as materials to which an electrode is transferred, many substances such as tantalum oxides, sapphire, organic layers (thick film layers), lipid layers, metal oxides, nitrogen oxides, silicon dioxide (SiO₂), gallium arsenides (GaASs) and compound semiconductors can be used.

Further, various steps of the invention are included in the above-described embodiment, and various inventions can be extracted by appropriately combining a plurality of disclosed components.

In addition, if several components are deleted from all the components described in the embodiment, the configuration from which several components have been deleted can be extracted as an invention in a case where the problem described in “Background Art” can be solved and the advantage described in “Industrial Applicability” can be obtained.

### INDUSTRIAL APPLICABILITY

According to the present invention, a microelectrode having superior characteristics can be formed without deforming and destructing molecular structures.

What is claimed is:

1. A method for manufacturing a microelectrode, comprising:
one of allocating organic molecules or forming an organic molecular layer on a first substrate;
applying a release agent onto a desired pattern formed on a second substrate;
attaching an electrode material to the release agent; and
bonding a surface of the second substrate to which the electrode material is attached and a surface of the first substrate on which the organic molecules are allocated or the organic molecular layer is formed to transfer the electrode material to the first substrate.

2. The method according to claim 1, wherein the electrode material is vapor-deposited on the release agent.

3. The method according to claim 1, wherein the electrode material is one of gold or platinum.

4. The method according to claim 1, wherein the pressure applied between the first and second substrates in performing a transfer is substantially 10,000N.

5. The method according to claim 1, wherein the transfer includes gradually separating the first and second substrates from each other after application of pressure to the first and second substrates gradually as they are closely-attached and maintained the maximum pressure for a predetermined period of time.

6. The method according to claim 1, wherein the release agent is solution.

7. The method according to claim 1, wherein the release agent is applied onto the desired pattern by spin coat method.

8. An microelectrode manufactured by means of the method according to claim 1.
